(19) United States
(12) Patent Application Publication
(10) Pub. No.: US 2025/0309624 A1
(43) Pub. Date: Oct. 2, 2025

(54) WIRE CONNECTION SYSTEM AND DEVICE

(71) Applicant: Star Blinds, LLC, Mapleton, UT (US)

(72) Inventors: Lindse Skinner, Mapleton, UT (US); James Skinner, Mapleton, UT (US)

(73) Assignee: Star Blinds, LLC, Mapleton, UT (US)

(21) Appl. No.: 19/091,358

(22) Filed: Mar. 26, 2025

Related U.S. Application Data
(60) Provisional application No. 63/569,911, filed on Mar. 26, 2024.

(51) Int. Cl. H02G 3/02; F16L 3/02

(52) U.S. Cl. CPC H02G 3/02; F16L 3/02

(57) ABSTRACT

Disclosed herein is a wire connection device that includes a head, a neck, and a base. The head includes a dock that has a first and second opening and a cutout. The neck is attached to the head and the base is attached to the neck. The base also includes a connector.

### PRIORITY CLAIM

This application claims the priority to and benefit of U.S. Provisional Application No. 63/569,911, filed on Mar. 26, 2024.

### TECHNICAL FIELD

The disclosure relates generally to a connection system and device for a charging cable.

### BACKGROUND

Window blinds have been an integral part of architecture and interior design, offering a delicate balance between functionality and aesthetic appeal. The evolution of window blinds has been a journey shaped by technological advancements, changing design preferences, and the pursuit of enhanced user experience.

The concept of window coverings dates back to ancient civilizations, where simple materials like reeds, bamboo, and fabric were used to create rudimentary blinds. These early window treatments were often employed for privacy, light control, and protection from the elements. Ancient Egyptian murals depict the use of reed mats as primitive window coverings, showcasing the early recognition of the importance of controlling sunlight and maintaining privacy.

In medieval Europe, the use of wooden shutters became prevalent. These shutters served both functional and decorative purposes, providing an effective barrier against the elements while incorporating intricate designs for added aesthetic appeal. The transition from basic coverings to more sophisticated designs marked a shift toward recognizing the potential of window treatments as elements of interior design.

The 18th century witnessed a significant development with the introduction of Venetian blinds. Originating in Persia, these blinds featured adjustable slats that could be manipulated to control the angle of sunlight entering a room. The design quickly gained popularity in Europe, and Venetian blinds became a symbol of refined taste and practical utility.

The 19th century saw the advent of spring-loaded roller blinds, providing a more convenient and controlled way to raise and lower window coverings. Additionally, innovations in materials, including the use of metal and synthetic fabrics, contributed to the durability and versatility of window blinds. These advancements laid the groundwork for the mass production of blinds and their widespread adoption in homes and commercial spaces.

The late 20th century witnessed a transformative phase with the integration of motorization and automation technologies into window blinds. This allowed users to control blinds remotely, enhancing convenience and accessibility. The advent of smart home technology further propelled this trend, enabling users to automate blind movements based on schedules, sunlight conditions, or user preferences.

In the present day, window blinds continue to evolve with a focus on energy efficiency, sustainability, and smart functionality. Innovations include blinds with built-in solar panels for energy generation, automated blinds that respond to environmental cues, and designs that seamlessly integrate with modern architecture. Because automation requires power, many window blinds are powered by rechargeable batteries. Often, these rechargeable batteries require connecting a charging cord to an out-of-reach motor. As a result, recharging may require a stool, ladder, or for some cases, an extension ladder. Therefore, charging these batteries can be dangerous, even fatal for anyone, especially for those with mobility issues. It is the object of this disclosure to present a safer way to connect a charger using a connection system and device as described below.

### SUMMARY

Disclosed herein is a wire connection device that includes a head, a neck, and a base. The head includes a dock that has a first and second opening and a cutout. The neck is attached to the head and the base is attached to the neck. The base also includes a connector.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. The advantages of the present disclosure will become better understood with regard to the following description and accompanying drawings:

FIG. 1 illustrates a front view of a wire connection device.

FIG. 2 illustrates a bottom perspective view of a wire connection device.

FIG. 3 illustrates a side view of a wire connection device.

FIG. 4 illustrates a top perspective view of a wire connection device with a charger.

FIG. 5 illustrates a top perspective partially exploded view of a wire connection device with a charger.

FIG. 6 illustrates a front-exploded view of a wire connection system and device with a charger.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

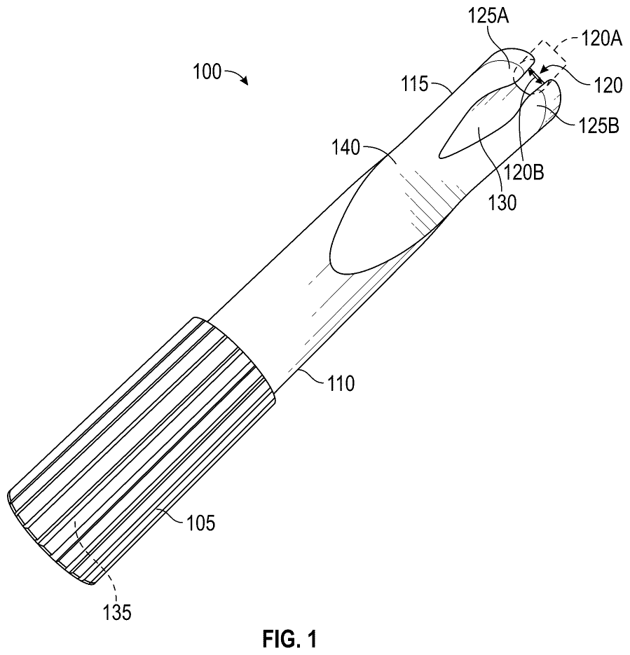

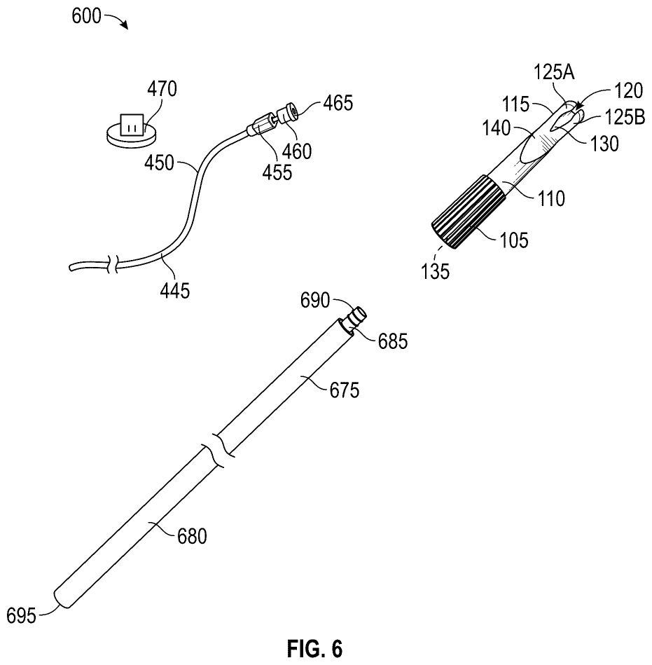

FIG. 1 illustrates a front view of wire connection device 100. Connection device 100 may include base 105 which may be removably attached to neck 110. Neck 110 may attach to head 115. A rough outer edge may surround the outside of base 105 to facilitate the grip of a user. Base 105 may include connector 135. Connector 135 may facilitate the attachment to an extension pole 675 (depicted in FIG. 6). Connector 135 may be threaded to attach to a common handle as found on a broom, mop, etc. Alternatively, connector 135 may include a pin locking, button locking, friction locking, magnet locking, or other permanent or detachable locking systems known in the art.

Neck 110 may be removably attached to base 105 to facilitate storage and/or to be able to position a different style of head 115 to accommodate a different sized or shaped charger. The attachment of neck 110 to base 105 may be threaded or include a pin, button, friction, magnetic, or other detachable locking system known in the art. Alternatively, neck 110 may be permanently attached to base 105 or may be composed of a single part that includes base 105, neck 110, and/or head 115.

Head 115 may include dock 120, forks 125A-B, and groove 130. Dock 120 may be comprised of an aperture that opens to the top of head 115 and to the front of head 115. The width of top opening 120A of dock 120 located at the top of head 115 may be greater than the width of front opening 120B located at the front of head 115. Accordingly, a portion of the cap and/or collar 455 of a charger may be sized to enter/exit through top opening 120A of dock 120 without being able to enter/exit front opening 120B. Further, top opening 120A may be sized smaller than the crown of the charger and may or may not be domed. As a result, a charger may be positioned within dock 120, through top opening 120A, without sliding through front opening 120B. Front opening 120B of dock 120 may be sized large enough to allow the wire of the charger to enter/exit. Front opening 120B separates left fork 125A and right fork 125B. The crown of the charger may rest on top portions of left and right forks 125A-B. The length of forks 125A-B may extend from the top portion of connection device 100 towards base 105. This length may vary in different embodiments. The portion of forks 125A-B nearest to the top extends further outward from a center point defined along the length of connection device 100 than the portion of forks 125A-B positioned nearer to base 105 of connection device 100. In other words, there may be cutout 140 positioned below forks 125A-B. Cutout 140 may be positioned within neck 110 or may extend to base 105. Groove 130 extends from top opening 120A of dock 120 downwards towards cutout 140. Groove 130 may allow the collar to be positioned within the groove 130. Further, cutout 140 may allow the wire to be set at an angle with respect to the length of the collar. The size of groove 130 and cutout 140 may also vary to best fit the charger.

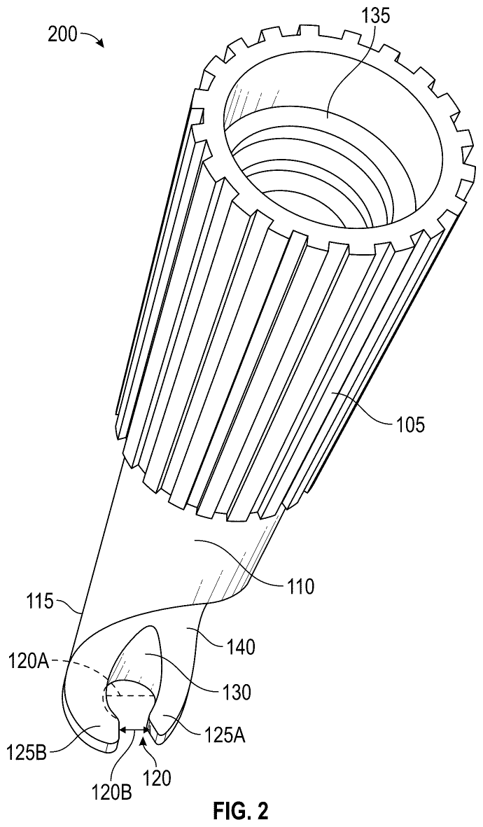

FIG. 2 illustrates a bottom perspective view of wire connection device 200. Connection device 200 may include base 105 which may be removably attached to neck 110. Neck 110 may attach to head 115. A rough outer edge may surround the outside of base 105 to facilitate the grip of a user. Base 105 may include connector 135. Connector 135 may facilitate the attachment to an extension pole 675 (depicted in FIG. 6). Connector 135 may be threaded, as depicted, to attach to a common handle as found on a broom, mop, etc. Alternatively, connector 135 may include a pin locking, button locking, friction locking, magnet locking, or other permanent or detachable locking systems known in the art.

Neck 110 may be removably attached to base 105 to facilitate storage and/or to be able to position a different style of head 115 to accommodate a different-sized or shaped charger. The attachment of neck 110 to base 105 may be threaded or include a pin, button, friction, magnetic, or other detachable locking system known in the art. Alternatively, neck 110 may be permanently attached to base 105 or may be composed of a single part that includes base 105, neck 110, and/or head 115.

Head 115 may include dock 120, forks 125A-B, and groove 130. Dock 120 may be comprised of an aperture that opens to the top of head 115 and to the front of head 115. The width of top opening 120A located at the top head 115 may be greater than the width of front opening 120B located at the front of head 115. Accordingly, a portion of the cap and/or the collar of a charger may be sized to enter/exit through top opening 120A of dock 120 without being able to enter/exit front opening 120B. Further, top opening 120A may be sized smaller than the crown of the charger. As a result, the charger may be positioned within dock 120, through top opening 120A, without sliding through front opening 120B. Front opening 120B of dock 120 may be sized large enough to allow the wire of the charger to enter/exit. Front opening 120B separates left fork 125A and right fork 125B. The crown of the charger may rest on the top portions of left and right forks 125A-B. The length of forks 125A-B may extend from the top portion of connection device 200 towards base 105. This length may vary in different embodiments. The portion of forks 125A-B nearest to the top extends further outward perpendicularly from a center point defined along the length of connection device 200 than the portion of forks 125A-B positioned nearer to base 105 bottom of connection device 200. In other words, there may be cutout 140 positioned below forks 125A-B. Groove 130 extends from top opening 120A of dock 120 downwards towards cutout 140. Groove 130 may allow the collar of the charger to be positioned within the groove 130. Cutout 140 may be positioned within neck 110 or may extend to base 105. Further, cutout 140 may allow the wire to be set at an angle with respect to the length of the collar. The size of groove 130 and cutout 140 may also vary to best fit the charger.

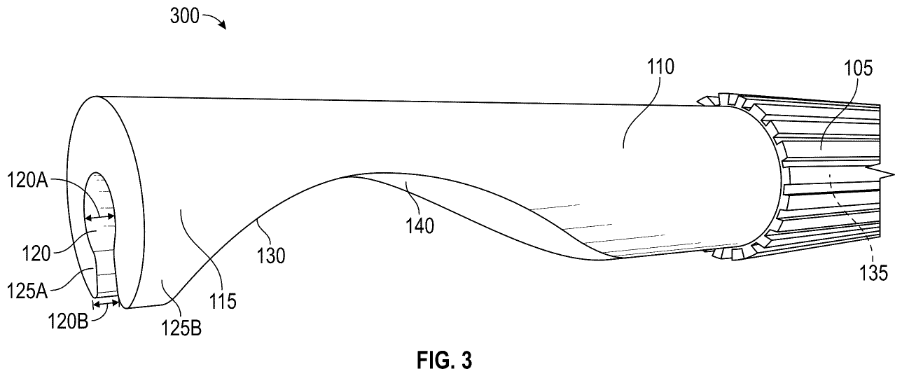

FIG. 3 illustrates a side view of wire connection device 300. Connection device 300 may include base 105 which may be removably attached to neck 110. Neck 110 may attach to head 115. A rough outer edge may surround the outside of base 105 to facilitate the grip of a user. Base 105 may include connector 135. Connector 135 may facilitate the attachment to an extension pole 675 (depicted in FIG. 6). Connector 135 may be threaded, as depicted, to attach to a common handle as found on a broom, mop, etc. Alternatively, connector 135 may include pin locking, button locking, friction locking, magnet locking, or other permanent or detachable locking systems known in the art.

Neck 110 may be removably attached to base 105 to facilitate storage and/or to be able to position a different style of head 115 to accommodate a different-sized or shaped charger. The attachment of neck 110 to base 105 may be threaded or include a pin, button, friction, magnetic, or other detachable locking system known in the art. Alternatively, neck 110 may be permanently attached to base 105 or may be composed of a single part that includes base 105, neck 110, and/or head 115.

Head 115 may include dock 120, forks 125A-B, and groove 130. Dock 120 may be comprised of an aperture that opens to the top of head 115 and to the front of head 115. The width of top opening 120A of dock 120 may be greater than the width of front opening 120B of dock 120. Accordingly, a portion of the cap and/or the collar of a charger may be sized to enter/exit through top opening 120A of dock 120 without being able to enter/exit front opening 120B of dock 120. Further, top opening 120A may be sized smaller than the crown of the charger. As a result, the charger may be positioned within dock 120, through top opening 120A, without sliding through front opening 120B. Front opening 120B of dock 120 may be sized large enough to allow the wire of the charger to enter/exit. Front opening 120B may separate left fork 125A and right fork 125B. The crown of the charger may sit on the top portions of left and right forks 125A-B. The length of forks 125A-B may extend from the top portion of connection device 200 towards base 105. This length may vary in different embodiments. The portion of forks 125A-B nearest to the top extends further outward from a center point defined along the length of connection device 300 than the portion of forks 125A-B positioned nearer to base 105 bottom of connection device 300. In other words, cutout 140 may be positioned below forks 125A-B. Groove 130 extends from top opening 120A of dock 120 downwards towards cutout 140. Groove 130 may allow the collar to be positioned within the groove 130. Cutout 140 may be positioned within neck 110 or may extend to base 105. Further, cutout 140 may allow the wire to be set at an angle with respect to the length of the collar. The size of groove 130 and cutout 140 may also vary to best fit the charger.

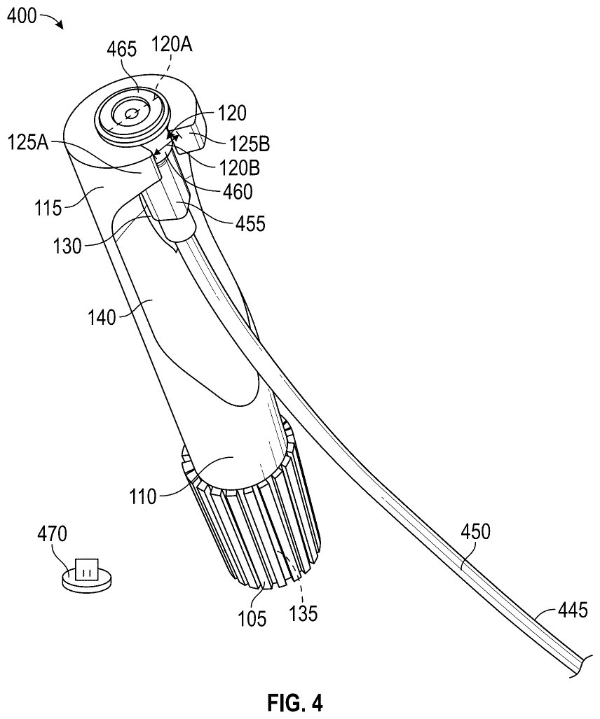

FIG. 4 illustrates a top perspective view of wire connection device 400 with charger 445. Connection device 400 may include base 105 which may be removably attached to neck 110. Neck 110 may attach to head 115. A rough outer edge may surround the outside of base 105 to facilitate the grip of a user. Base 105 may include connector 135. Connector 135 may facilitate the attachment to an extension pole 675 (depicted in FIG. 6). Connector 135 may be threaded, as depicted, to attach to a common handle as found on a broom, mop, etc. Alternatively, connector 135 may include pin locking, button locking, friction locking, magnet locking, or other permanent or detachable locking systems known in the art.

Neck 110 may be removably attached to base 105 to facilitate storage and/or to be able to position a different style of head 115 to accommodate a different sized or shaped charger 445. The attachment of neck 110 to base 105 may be threaded or include a pin, button, friction, magnetic, or other detachable locking system known in the art. Alternatively, neck 110 may be permanently attached to base 105 or may be composed of a single part that includes base 105, neck 110, and/or head 115.

Head 115 may include dock 120, forks 125A-B, and groove 130. Dock 120 may be comprised of an aperture that opens to the top of head 115 and to the front of head 115. The width of top opening 120A of dock 120 may be greater than the width of front opening 120B of dock 120. Accordingly, a portion of cap 460 and/or collar 455 of charger 445 may be sized to enter/exit through top opening 120A of dock 120 without being able to enter/exit front opening 120B of dock 120. Further, top opening 120A may be sized smaller than crown 465 of charger 445. As a result, the charger 445 may be positioned within dock 120, through top opening 120A, without sliding through front opening 120B. Front opening 120B of dock 120 may be sized large enough to allow wire 450 of charger 445 to enter/exit. Front opening 120B may separate left fork 125A and right fork 125B. Crown 465 of charger 445 may sit on the top portions of left and right forks 125A-B. The length of forks 125A-B may extend from the top portion of connection device 200 towards base 105. This length may vary in different embodiments. The portion of forks 125A-B nearest to the top of connection device 400 extends further outward perpendicularly from a center point defined along the length of connection device 400 as compared to the portion of forks 125A-B positioned nearer to base 105 at the bottom of connection device 400. In other words, there may be cutout 140 positioned below forks 125A-B. Groove 130 extends from top opening 120A of dock 120 downwards towards cutout 140. Groove 130 may allow collar 455 to be positioned within the groove 130. Cutout 140 may be positioned within neck 110 or may extend to base 105. Further, cutout 140 may allow the wire to be set at an angle with respect to the length of the collar. The size of groove 130 and cutout 140 may also vary to best-fit charger 445.

In practice, wire 450, just below collar 455, may be placed through front opening 120B of dock 120 between left fork 125A and right fork 125B. After, wire 450 is slid downward seating cap 460 and collar 455 within dock 120 and/or groove 130. Portions of cap 460 and/or collar 455 contact forks 125A-B. Crown 465 may be sized larger than cap 460 and larger than top opening 120A of dock 120 such that crown 465 sits on top of top opening 120A of dock 120. Charger 445 may include a hinge between cap 460 and collar 455. Forks 125A-B may be positioned in a manner that the contact between forks 125A-B and cap 460 when inserted, allows movement of collar 455. This may be based on the length, thickness, size, and shape of forks 125A-B and the position of the hinge and collar 455 in relation to forks 125A-B. Further, cutout 140 and groove 130 may also allow or facilitate movement. Accordingly, wire 450 may swing freely as cap 460 and crown 465 are maintained removably fixed within dock 120. Removably fixed in this context means minimal movement downward and along a horizontal plane perpendicular to the length of connection device 400. Further, wire 450 is removable because if connection device 400 is moved upwards from dock 120 such that collar 455, cap 460, and crown 465 are placed above dock 120 wire 450 may slide through front opening 120B of dock 120 between forks 125A-B and be removed from connection device 400.

To facilitate the removal of charger 445 from connection device 400 magnetic adapter 470 may be placed in the charging port of the device that needs charging such as a motorized window covering. Furthermore, crown 465 may include a magnet positioned in a way that is magnetically attracted to adapter 470. Once adapter 470 is placed in the charging point, charger 445 is placed in connection device 400, and connection device 400 is placed on or near adapter 470, charger 445 may connect to adapter 470. The magnetic attraction alone may cause charger 445 to leap out of connection device 400 separating charger 445 from connection device 400. In other words, once the connection between charger 445 and adapter 470 is made, connection device 400 may be lowered allowing cap 460 and collar 455 to be raised out of top opening 120A of dock 120. This in turn may allow wire 450 to slide out of front opening 120B of dock 120 between forks 125A-B.

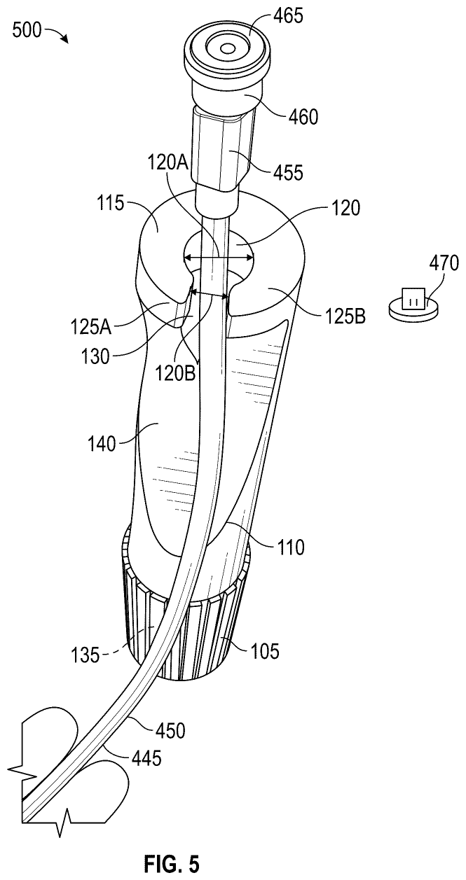

FIG. 5 illustrates a top perspective partially exploded view of a wire connection device 500 with charger 445. Connection device 500 may include base 105 which may be removably attached to neck 110. Neck 110 may attach to head 115. A rough outer edge may surround the outside of base 105 to facilitate the grip of a user. Base 105 may include connector 135. Connector 135 may facilitate the attachment to an extension pole 675 (depicted in FIG. 6). Connector 135 may be threaded, as depicted, to attach to a common handle as found on a broom, mop, etc. Alternatively, connector 135 may include pin locking, button locking, friction locking, magnet locking, or other permanent or detachable locking systems known in the art.

Neck 110 may be removably attached to base 105 to facilitate storage and/or to be able to position a different style of head 115 to accommodate a different sized or shaped charger 445. The attachment of neck 110 to base 105 may be threaded or include a pin, button, friction, magnetic or other detachable locking system known in the art. Alternatively, neck 110 may be permanently attached to base 105 or may be composed of a single part that includes base 105, neck 110, and/or head 115.

Head 115 may include dock 120, forks 125A-B, and groove 130. Dock 120 may be comprised of an aperture that opens to the top of head 115 and to the front of head 115. The width of top opening 120A of dock 120 may be greater than the width of front opening 120B of dock 120. Accordingly, a portion of cap 460 and/or collar 455 of charger 445 may be sized to enter/exit through top opening 120A of dock 120 without being able to enter/exit front opening 120B. Further, top opening 120A may be sized smaller than crown 465 of charger 445. As a result, the charger 445 may be positioned within dock 120, through top opening 120A, without sliding through front opening 120B. Front opening 120B of dock 120 may be sized large enough to allow wire 450 of charger 445 to enter/exit. Front opening 120B may separate left fork 125A and right fork 125B. Crown 465 of charger 445 may sit on left and right forks 125A-B. The length of forks 125A-B may extend from the top portion of connection device 200 towards base 105. This length may vary in different embodiments. The portion of forks 125A-B nearest to the top extends further outward perpendicularly from a center point defined along the length of connection device 500 than the portion of forks 125A-B positioned nearer to base 105 at the bottom of connection device 500. In other words, there may be cutout 140 positioned below forks 125A-B. Groove 130 extends from top opening 120A of dock 120 downwards towards cutout 140. Groove 130 may allow collar 455 to be positioned within the groove 130. Cutout 140 may be positioned within neck 110 or may extend to base 105. Further, cutout 140 may allow the wire to be set at an angle with respect to the length of the collar. The size of groove 130 and cutout 140 may also vary to best fit charging cable 445.

In practice, wire 450, just below collar 455, is placed through front opening 120B of dock 120 between left fork 125A and right fork 125B. After, wire 450 is slid downward seating cap 460 and collar 455 with in dock 120 and/or groove 130. Portions of cap 460 and/or collar 455 contact forks 125A-B. Crown 465 may be sized larger than cap 460 and larger than top opening 120A of dock 120 such that crown 465 sits on top of top opening 120A of dock 120. Charger 445 may include a hinge between cap 460 and collar 455. Forks 125A-B may be positioned in a manner that the contact between forks 125A-B and cap 460 when inserted, allows movement of collar 455. This may be based on the length, thickness, size, and shape of forks 125A-B and the position of the hinge and collar 455 in relation to forks 125A-B. Further cutout 140 and groove 130 may also allow or facilitate the movement of wire 450. Accordingly, wire 450 may swing freely as cap 460 and crown 465 are maintained removably fixed within dock 120. Removably fixed in this context means minimal movement downward and along a horizontal plane perpendicular to the length of connection device 500. Further, it is removable because if the connection device is moved upwards from dock 120 such that collar 455, cap 460, and crown 465 are placed above top opening 120A of dock 120 wire 450 may slide through front opening 120B of dock 120 between forks 125A-B and be removed from connection device 500.

To facilitate the removal of charging cable 445 from connection device 500 magnetic adapter 470 may be placed in the charging port of the device that needs charging such as a motor of a motorized window covering. Furthermore, crown 465 may include a magnet positioned in a way that is magnetically attracted to adapter 470. Once adapter 470 is placed in the charging point, charging cable 500 is placed in connection device 500, and connection device 500 is positioned on or near adapter 470, crown 465 may connect to adapter 470. The magnetic attraction alone may cause charger 445 to leap out of connection device 500 separating charger 445 from connection device 500. In other words, once the connection between charger 445 and adapter 470 is made, connection device 500 may be lowered allowing cap 460 and collar 455 to be raised out of top opening 120A of dock 120. This in turn may allow wire 450 to slide out of front opening 120B of dock 120 between forks 125A-B.

FIG. 6 illustrates a front exploded view of wire connection system 600 with charging cable 445. Connection device 600 may include base 105 which may be removably attached to neck 110. Neck 110 may attach to head 115. A rough outer edge may surround the outside of base 105 to facilitate the grip of a user. Base 105 may include connector 135. Connector 135 may facilitate the attachment to an extension pole 675. Connector 135 may be threaded, as depicted, to attach to extension pole 675. Extension pole 675 may be a broom, mop, etc. Further extension pole 675 may include tip 685 which may comprise the area that interacts with connector 135 of base 105. Tip 685 may include coupler 690 that may interact with the connector 135. Connector 135 may include pin locking, button locking, friction locking, magnet locking, or other permanent or detachable locking systems known in the art. Extension pole 675 may also include an additional pole 680 and pole base 695. Base 695 may receive additional poles 680 or may attach to a grip or a cushion to make it easier to handle or to avoid scratching other surfaces.

Neck 110 may be removably attached to base 105 to facilitate storage and/or to be able to position a different style of head 115 to accommodate a different sized or shaped charging cable 445. The attachment of neck 110 to base 105 may be threaded or include a pin, button, friction, magnetic, or other detachable locking systems known in the art. Alternatively, neck 110 may be permanently attached to base 105 or may be composed of a single part that includes base 105, neck 110, and/or head 115.

Head 115 may include dock 120, forks 125A-B, and groove 130. Dock 120 may be comprised of an aperture that opens to the top of head 115 and to the front of head 115. The width of top opening 120A (not numbered in FIG. 6 because of the figure size but it is depicted) of dock 120 may be greater than the width of front opening 120B (depicted in FIG. 6 and discussed above) of dock 120. Accordingly, a portion of cap 460 and/or collar 455 of charging cable 445 may be sized to enter/exit through top opening 120A of dock 120 without being able to enter/exit front opening 120B. Further, top opening 120A may be sized smaller than crown 465 of charging cable 445. As a result, the charger 445 may be positioned within dock 120, through top opening 120A, without sliding through front opening 120B. Front opening 120B of dock 120 may be sized large enough to allow wire 450 of charging cable 445 to enter/exit. Front opening 120B may separate left fork 125A and right fork 125B. Crown 465 of charging cable 445 may sit on left and right forks 125A-B.

The length of forks 125A-B may extend from the top portion of connection device 200 towards base 105. This length may vary in different embodiments. The portion of forks 125A-B nearest to the top extends further outward from a center point defined along the length of connection device 600 than the portion of forks 125A-B positioned nearer to base 105 at the bottom of connection device 600. In other words, there may be cutout 140 positioned below forks 125A-B. Groove 130 extends from top opening 120A of dock 120 downwards towards cutout 140. Groove 130 may allow collar 455 to be positioned within the groove 130. Cutout 140 may be positioned within neck 110 or may extend to base 105. Further, cutout 140 may allow the wire to be set at an angle with respect to the length of the collar. The size of groove 130 and cutout 140 may also vary to best fit charging cable 445. For example, at least a portion of charger 445 may be larger than top opening 120A of docket 120 allowing charger 445 to rest on the top ends of forks 125A-B.

In practice, extension pole 675 which may include tip 685 and coupler 690 may attach to connector 135 of base 105. Extension pole 675 may attach to an additional pole 680 that may include pole base 695 to facilitate attachment of an additional pole 680 or to attach a grip or some sort of cap with softer material to avoid causing damage to other surrounding objects. Subsequently, or prior to wire 450, just below collar 455, is placed through front opening 120B of dock 120 between left fork 125A and right fork 125B. After, wire 450 is slid downward seating cap 460 and collar 455 with in dock 120 and/or groove 130. Portions of cap 460 and/or collar 455 may contact forks 125A-B. Crown 465 may be sized larger than cap 460 and larger than top opening 120A of dock 120 such that crown 465 sits on top of top opening 120A of dock 120. Charger 445 may include a hinge between cap 460 and collar 455. Forks 125A-B may be positioned in a manner that the contact between forks 125A-B and cap 460 when inserted, allows movement of collar 455. This may be based on the length, thickness, size, and shape of forks 125A-B and the position of the hinge and collar 455 in relation to forks 125A-B. Further cutout 140 and groove 130 may also allow or facilitate movement. Accordingly, wire 450 may swing freely as cap 460 and crown 465 are maintained removably fixed within dock 120. Removably fixed in this context means minimal movement downward and along a horizontal plane perpendicular to the length of connection device 400. Further, it is removable because if connection device 600 is moved upwards from dock 120 such that collar 455, cap 460, and crown 465 are placed above top opening 120A of dock 120 wire 450 may slide through front opening 120B of dock 120 between forks 125A-B and be removed from connection device 400.

To facilitate the removal of charging cable 445 from connection device 400 magnetic adapter 470 may be placed in the charging port of the device that needs charging such as a motorized window covering. Furthermore, crown 465 may include a magnet positioned in a way that is magnetically attracted to adapter 470. Once adapter 470 is placed in the charging point, charging cable 500 is placed in connection device 600, and connection device 600 is positioned on or near adapter 470, crown 465 may connect to adapter 470. The magnetic attraction alone may cause charger 445 to leap out of connection device 400 separating charger 445 from connection device 400. In other words, once the connection between charger 445 and adapter 470 is made, connection device 600 may be lowered allowing cap 460 and collar 455 to be raised out of top opening 120A of dock 120. This in turn may allow wire 450 to slide out of front opening 120B of dock 120 between forks 125A-B.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered exemplary only, with a true scope and spirit of the invention being indicated by the following claims.

What is claimed is:

1. A wire connection device comprising:
a head comprising:
a dock comprising:
a top opening;
a front opening;
a cutout;
a neck attached to the head; and
a base attached to the neck comprising:
a connector.

2. The wire connection device of claim 1, wherein the connector is a threaded connector.

3. The wire connection device of claim 1, wherein the cutout reduces a thickness of the neck such that a thickness of the cutout is smaller than the thickness of the neck.

4. The wire connection device of claim 1, wherein the front opening is at least partially disposed in the cutout.

5. The wire connection device of claim 4, wherein the cutout includes a groove disposed in the cutout.

6. The wire connection device of claim 1, wherein the top opening is disposed in a top of the head.

7. The wire connection device of claim 1, wherein the top opening and the front opening are connected to accommodate a wire.

8. The wire connection device of claim 7, wherein the front opening is large enough to accept the wire.

9. The wire connection device of claim 8, wherein the top opening is smaller than a crown of the wire.

10. The wire connection device of claim 1, wherein the front opening is separated by a first fork and a second fork.

11. A wire connection system comprising
a wire connection device comprising:
a head comprising:
a dock comprising:
a top opening;
a front opening;
a cutout;
a neck attached to the head;
a base attached to the neck comprising:
a connector; and
an extension pole.

12. The wire connection device of claim 11, wherein the connector is a threaded connector.

13. The wire connection device of claim 11, wherein the cutout reduces a thickness of the neck such that a thickness of the cutout is smaller than the thickness of the neck.

14. The wire connection device of claim 11, wherein the front opening is at least partially disposed in the cutout.

15. The wire connection device of claim 14, wherein the cutout includes a groove disposed in the cutout.

16. The wire connection device of claim 1, wherein the top opening is disposed in a top of the head.

17. The wire connection device of claim 1, wherein the top opening and the front opening are connected to accommodate a wire.

18. The wire connection device of claim 17, wherein the front opening is large enough to accept the wire.

19. The wire connection device of claim 18, wherein the top opening is smaller than a crown of the wire.

20. The wire connection device of claim 1, wherein the front opening is separated by a first fork and a second fork.
